(19) United States
(12) Patent Application Publication
(10) Pub. No.: US 2007/0170043 A1
(43) Pub. Date: Jul. 26, 2007

(54) Conveyor for material with magnetically driven flights in a tube

(76) Inventor: Leon Fatima Peter Hendrik Lambert Raijmakers, Uden (NL)

Correspondence Address: YOUNG & THOMPSON, 745 SOUTH 23RD STREET, 2ND FLOOR, ARLINGTON, VA, 22202, US

(21) Appl. No.: 10/581,337

(22) PCT Filed: Dec. 2, 2004
(86) PCT No.: PCT/NL04/00840

§ 371 Date: Jun. 22, 2006

(30) Foreign Application Priority Data
Dec. 3, 2003 (NL) 1024940
Mar. 31, 2004 (NL) 1025855

(51) Int. Cl. B65G 19/14

(52) U.S. Cl. 198/805; 198/716; 198/717; 198/727; 198/728

(57) ABSTRACT

The invention relates to a conveyor for material, comprising a circulating tube (64) circuit, a series of conveyor flights (63) placed so as to be movable in the circulating tube circuit, comprising one or more first conveyor flights comprising a component made of an electrically conductive and/or magnetic material, one or more spacers (62) for spacing apart the conveyor flights in the circulating tube circuit, and a drive mechanism comprising a number of coils (70) placed successively along a drive member of the circulating tube circuit, which coils generate a varying magnetic field within a drive path for driving the first conveyor flights situated within the drive path in a drive direction.

The invention relates to a tube conveyance device for conveying through a tube circuit, material of fluid properties, particularly for liquids, gases and bulk goods such as for instance granulates (for instance sand, cement, cereals, sugar, peanuts, cocoa beans or powdered milk), but also other materials such as tobacco leaves or tea leaves. The invention further relates to a drive mechanism for a conveyor.

Up until now for instance a tube conveyance device as for instance described in European patent application 0 422 261 has been used for the conveyance of goods. This device comprises a circulating tube circuit provided with an inlet and an outlet. A series of spaced apart conveyor flights has been placed in the tube circuit, which conveyor flights are provided with a disk-shaped body that snugly fits against the inside of the inner wall of the tube circuit. The disk-shaped bodies of the conveyor flights are provided with a core of magnetic material, such as for instance magnetic steel. In the straight portions of the circulating tube circuit at least two electromagnets that are reciprocally movable along the tube circuit have been placed, which electromagnets are each provided with displacement means for reciprocally moving the respective electromagnets. The electromagnets can be reciprocally moved by means of mechanic, electric, pneumatic or hydraulic devices. Switching the electromagnets on and off is synchronised with the reciprocal motion of the electromagnets. If an electromagnet is moved in the conveyance direction, the electromagnet is switched on as a result of which the conveyance disks that are positioned near said electromagnet are taken along by said electromagnet in conveyance direction. In the return motion, counter the conveyance direction, the electromagnet is switched off, as a result of which this electromagnet does not influence the conveyance disks. By reciprocally moving the two or more electromagnets in antiphase, the conveyance disks can be more or less continuously moved steadily through the tube circuit for conveying delicate products along with the conveyance disks.

A drawback of the known device is the limited conveyance capacity, which is mainly caused by the limited speed at which the conveyor flights move through the tube circuit.

It is an object of the invention to improve on this.

To that end the invention provides a conveyor for material, comprising
a circulating tube circuit,
a series of conveyor flights placed so as to be movable in the circulating tube circuit, comprising one or more first conveyor flights comprising a component made of an electrically conductive and/or magnetic material,
one or more spacers for spacing apart the conveyor flights in the circulating tube circuit, and
a drive mechanism comprising a number of coils placed consecutively along a drive member of the circulating tube circuit, which coils generate a varying magnetic field within a drive path for driving the first conveyor flights situated within the drive path in a drive direction.

By using a number of consecutively placed coils and varying the magnetic field of the individual coils the first conveyor flights can successively be attracted and/or repulsed by the consecutive coils for driving a motion of said conveyor flights through the tube circuit. For driving the conveyor flights of the device according to the invention the magnetic fields in the coils are varied, for instance by varying the current through the coils. As a result it is no longer necessary that the drive mechanism has to be reciprocally moved, as is the case in the known device according to European patent application 0 422 261. The drive mechanism according to the invention therefore preferably is fixedly placed along the drive member of the circulating tube circuit, wherein the coils are preferably electrically or electronically driven for varying the magnetic fields. A quick electric or electronic control is able to drive the conveyor flights at a higher speed through the tube circuit than the known drive, as a result of which the conveyance capacity of the device according to the invention can be higher than the one of the device according to European patent application 0 422 261.

A further drawback of the device according to European patent application 0 422 261 is that the drive mechanism is provided with moving parts for reciprocally moving the drive mechanism along the tube circuit. Said moving parts are subject to wear and may in the long run adversely affect the functioning of the conveyor; for instance because worn parts have to be replaced, as a result of which the conveyor during the replacement operations cannot be used and because of which costs have to be incurred for new parts. The device according to the invention is provided with a drive mechanism in which no moving parts are necessary, as a result of which the above-mentioned drawbacks can be avoided to a large extent.

A further advantage of such a device is that no physical contact between the drive mechanism and the conveyor flights is necessary in order to drive them. If the tube circuit, at least a portion near the coils, is made substantially of a material through which the magnetic field is able to penetrate within the tube circuit, such as for instance a non-magnetic material such as for instance synthetic material, the magnets for driving the conveyor flights can be disposed at or near the outer side of the tube circuit. The drive mechanism can then be placed outside of the tube circuit, as a result of which it cannot be a source of contamination of the inside of the tube circuit and/or the conveyance means either. This is among other things advantageous for using the conveyor according to the invention in for instance the pharmaceutical or foodstuff industry, where contamination needs to be reduced to a minimum.

In an embodiment the coils may comprise windings that are wound around the drive member of the circulating tube circuit. Preferably the coils comprise loop-shaped or saddle-shaped windings that at least partially enclose the drive member of the tube circuit. Preferably the loop-shaped or saddle-shaped windings can be folded open for placing said windings around the drive member of the tube circuit. Thus the coils according to this embodiment can easily be placed and/or removed without the tube circuit having to be fully or partially disassembled to that end.

In an embodiment the drive mechanism comprises a controlling device for controlling the coils for generating a magnetic field that travels along the drive path. The first conveyor flights are taken along by the travelling magnetic field and thus moved onwards in a driven manner through the tube circuit. The drive mechanism can thus be formed like a linear electric machine, such as for instance a linear induction motor, wherein the windings are placed along the drive member of the tube circuit.

In an embodiment the drive mechanism comprises sensors for detecting a position of at least a conveyor flight in the tube circuit, and wherein the sensors are connected to the controlling device for transmitting data regarding the position to the controlling device. Preferably the sensors and/or the controlling device are adapted for determining the speed of the first conveyor flight. Said sensors may be used for registering the movement of the conveyor flights through the tube circuit, in order for instance to guard the proper functioning of the conveyor according to the invention.

Preferably the sensors are adapted for detecting the position and/or speed of at least a first conveyor flight with respect to the coils. To that end the sensors are preferably placed upstream of the coils and/or between the windings of the coils. Said sensors can be used for registering the movement of at least the first conveyor flights at least near or in the drive mechanism.

Preferably the controlling device is adapted for excitation of the coils in dependency on the position and/or the speed of the first conveyor flights. Thus the controlling of the coils by the controlling device can be synchronised with the position and/or the movement of the first conveyor flights. This embodiment is particularly advantageous for efficiently controlling a device according to the invention wherein the mutual distance between the first conveyor flights may vary.

In an embodiment the drive mechanism is placed along a substantially straight portion of the tube circuit. Preferably the drive member is placed in or near a bend in the tube circuit. Apart from having a driving force, the coils may also exert a radial force on the first conveyor flights with respect to the conveyance tube of the tube circuit. Said radial force can be utilised for guiding the conveyor flights through the bend. In this way it can for instance be largely prevented that in a bend the conveyor flights rub against the inner wall of the tube circuit. Due to this rubbing the conveyance means is namely decelerated, which may adversely affect the operation and/or the energy use of the conveyor.

In a first embodiment the one or more spacers comprise a circulating endless conveyance means, wherein said conveyor flights are coupled to the conveyance means at least a regular distance from each other. The conveyance means preferably comprises an endless cable or chain provided with the series of conveyor flights, for instance in the form of conveyance disks, that are regularly spaced apart along the cable or chain.

In a second embodiment the conveyor flights each comprise a spacer, wherein the spacer projects from the conveyor flights in the direction of a next adjacent conveyor flight in the tube circuit. As the drive mechanism engages onto the conveyor flights and the spacers of the conveyor flights ensure the correct mutual distance between the conveyor flights, a mutual coupling of the conveyor flights by means of an endless cable or chain like in the above-mentioned embodiment, is not longer necessary. The individual conveyor flights can successively be placed separately in the tube circuit, wherein a spacer of a first conveyor flight can abut an adjacent second conveyor flight. When said first conveyor flight is being driven, it will push forth the second and further conveyor flights positioned downstream. In such a way the conveyor flights placed one after the other will form a train of conveyor flights that push each other forth.

This second embodiment offers great advantages:

First of all the conveyor flights can simply be placed separately in the tube circuit and removed separately from the tube circuit. By using separate conveyor flights maintenance and cleaning the conveyor can be done more easily. Moreover the mounting of the conveyor is considerably simplified; the chain or cable need no longer be passed through the tube circuit and then be formed into an endless cable or chain. Said coupling of the ends of the cable or chain appeared to be a weak point in the structure.

Secondly the length of the conveyor can easily be adjusted. As long as the overall length is substantially equal to an overall number of times the length of a conveyor flight including spacer, then this number of conveyor flights, preferably with some play, can be placed in the tube circuit.

Preferably the spacer of a first conveyor flight is provided with a first abutment surface at a side facing away from said conveyor flight. This first abutment surface is adapted for, at least during pushing forth an adjacent conveyor flight situated downstream, abutting a second abutment surface of the adjacent conveyor flight.

Preferably the conveyor flights are placed separate from each other in the tube circuit. Preferably, at least during the circulation of the conveyor flights through the tube circuit, the first abutment surface does not continuously abut the second abutment surface. When for instance the adjacent conveyor flight situated downstream is driven by the drive mechanism and the first conveyor flight is not subjected to driving force yet at that moment, the first and second abutment surface may become separated from each other. A possible accumulation of the material to be conveyed between the first and second abutment surface can at least be largely prevented in this way.

In this second embodiment the spacer of a first conveyor flight can be coupled to a second conveyor flight. As a result such a first conveyor flight is able to pull along a further conveyor flight situated upstream and push forth a further conveyor flight situated downstream.

In an embodiment each of the conveyor flights comprises at least one disk-shaped body having an outer circumference that is at least almost equal to the inner circumference of the tube circuit. Preferably the outer circumference of the disk-shaped bodies is such that said disk-shaped bodies fit in the conveyance tube of the tube circuit with play. As a result the friction between the outer circumference of the disk-shaped bodies and the inner wall of the conveyance tube can be reduced, as a result of which a smooth course of the disk-shaped bodies through the tube circuit can be achieved. In addition air whirls between the conveyor flights may arise as a result of the play and a high speed of the conveyor flight through the tube circuit, which whirls may bring the granulates to be conveyed into a fluid condition, like in a fluidised bed. In the fluid condition granulates are quicker and easier to convey.

Preferably the disk-shaped body comprises a circumferential edge which circumferential edge projects out of the plane of the disk-shaped body. Preferably the circumferential edge projects substantially perpendicular out of the plane of the disk-shaped body. Preferably the circumferential edge on both sides of the disk-shaped body projects out of the plane of the disk-shaped body. Due to the circumferential edge the disk-shaped body acquires a cylindrical circumferential plane, as a result of which tilting of the disk-shaped body can at least be prevented to a large extent. The cylindrical circumferential plane ensures guidance of the disk-shaped body through the tube circuit.

When the conveyor flights including a disk-shaped body are furthermore provided with spacers, the one or more spacers preferably substantially connect to the centre of the disk-shaped body. Preferably one of the one or more spacers extends along the axis of the disk-shaped body, substantially perpendicular to the plane of the disk.

Preferably at a first end surface of the disk-shaped body, the disk-shaped body comprises the one or more spacers provided with a first abutment surface at a side of the spacer facing away from the disk-shaped body, and at a second end surface of the disk-shaped body, the disk-shaped body comprises a second abutment surface.

Preferably the conveyor flights, at least at their outer side, comprise a layer of polyethene, preferably polyethene of an ultra high molecular weight (referred to as UHMWPE). This synthetic material namely is very tough and wear-resistant.

In an embodiment at least a part of the conveyor flights, particularly the first conveyor flights, comprise first magnets, preferably Nd-magnets. As a result the movements of said conveyor flights in the tube circuit can be influenced by means of magnetic fields. Nd-magnets are preferred in this case as they have a strong magnetic field.

Preferably the first magnets are placed in the disk-shaped body of the conveyor flights. Preferably metal plates are placed on both sides of the first magnets, preferably said metal plates extend substantially parallel with respect to the end surfaces of the disk-shaped body. Preferably the metal plates comprise steel plates.

In a further embodiment the conveyor comprises one or more magnet means placed along the tube circuit for generating a magnetic field for urging at least the part of the first conveyor flights provided with a magnet to the centre of a tube of the tube circuit. Preferably the conveyance tube of at least a part of the tube circuit at least near the magnet means, is substantially made of a non-magnetic material, preferably of synthetic material. Said magnet means are preferably placed in or near a bend in the tube circuit where no drive mechanism has been placed. The magnet means may form a guiding device for guiding the conveyor flights through the bend. Because of such a guiding device it may for instance be prevented to a large extend that in a bend the conveyor flights provided with magnets or ferromagnetic materials rub against the inner wall of the tube circuit.

In an embodiment the magnet means comprise electromagnets. As a result the strength of the magnetic fields can be adjusted to the desired values, due to which the operation of the conveyor can be optimised. Preferably the strength of the magnetic fields is controlled depending on the speed of the conveyor flights through the tube circuit, such as for instance determined by means of the sensors described above.

In an embodiment a conveyance tube of at least a part of the tube circuit near a drive mechanism and/or guiding device is substantially made of synthetic material, for instance of polyurethane (PU).

Preferably the conveyance tube is substantially made of an electrically conductive synthetic material and/or provided with an electrically conductive layer for discharging static electricity. Preferably the electrically conductive layer is disposed at the outer side of the conveyance tube, wherein the electrically conductive layer preferably comprises a carbon-filled synthetic material, preferably a carbon-filled recycled synthetic material, such as a so-called regenerate.

In an embodiment a wall of the conveyance tube of at least a part of the tube circuit is provided with one or more guides placed in the tube circuit and extending along the drive direction, which guides guide a medium, such as for instance light, electricity, a fluid or a fluid pressure, wherein the conveyor comprises a wear sensor which is connected to the one or more guides for detecting deviations in the medium, such as for instance a variation in the light intensity, electric voltage or fluid pressure. If the inner wall is worn to such an extent that the guide comes to the surface there, this will be detectable by the wear sensor. Thus the wear sensor will monitor the degree of wear of the inner side of at least the synthetic part of the conveyance tube, and a worn conveyance tube or at least a worn part thereof, can be timely replaced. Said device for detecting wear of a conveyance tube can furthermore be used in other tubes and different types of conveyance devices, such as for instance in a conveyor belt of a belt conveyor, a vibrating trough or a slide.

The invention furthermore provides a drive mechanism suitable and intended for driving a conveyor as described above.

The invention furthermore provides a conveyor flight suitable and intended for driving a conveyor as described above.

The invention furthermore provides a conveyance tube suitable and intended for driving a conveyor as described above.

The invention further provides a guiding device for a conveyor for material comprising a circulating tube circuit, a series of conveyor flights placed so as to be the movable in the circulating tube circuit, comprising one or more first conveyor flights comprising a component made of a magnetic material, one or more spacers for spacing the conveyor flights apart from each other in the circulating tube circuit, wherein the guiding device comprises one or more magnet means placed along the tube circuit for generating a magnetic field for urging at least the first conveyor flights to the centre of a tube of the tube circuit.

The invention will be further elucidated on the basis of the exemplary embodiment shown in the attached drawings, in which:

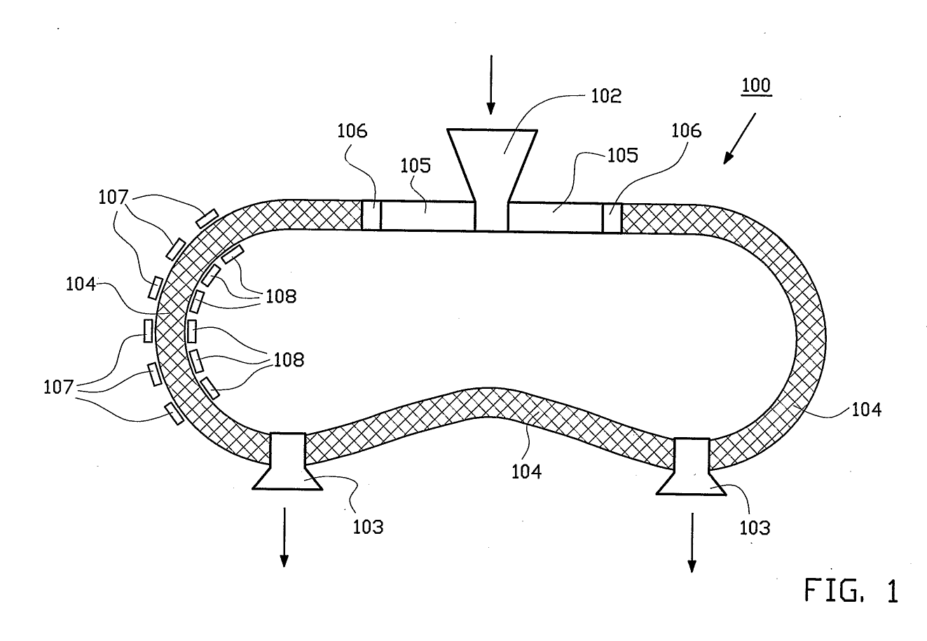

FIG. 1 shows a schematic view of an exemplary embodiment of a conveyor according to the invention;

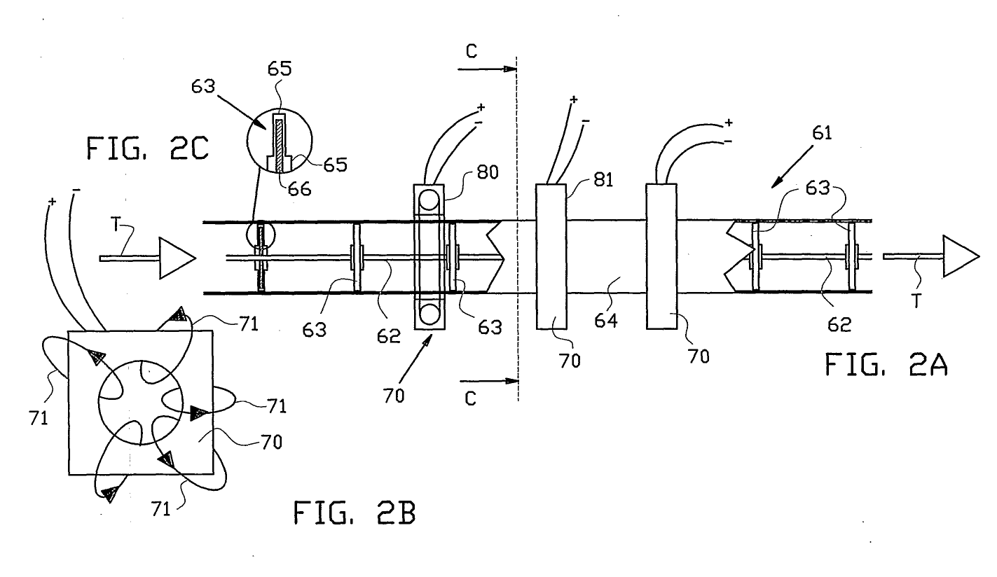

FIGS. 2A, 2B and 2C show schematic views, at least partially in cross-section, of an exemplary embodiment of a drive mechanism for a conveyor according to the invention;

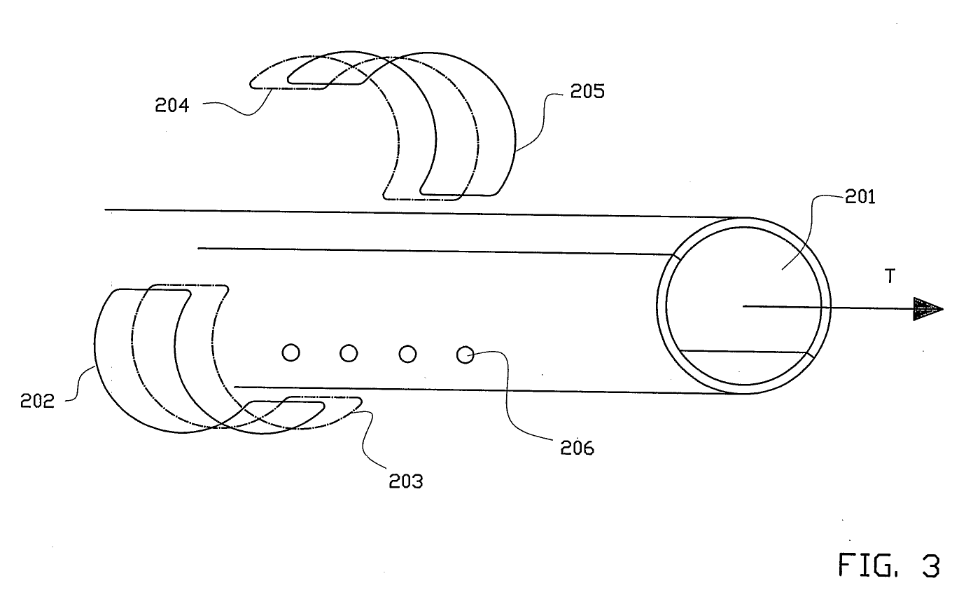

FIG. 3 shows a schematic exploded, view of an exemplary embodiment of a magnetic drive mechanism;

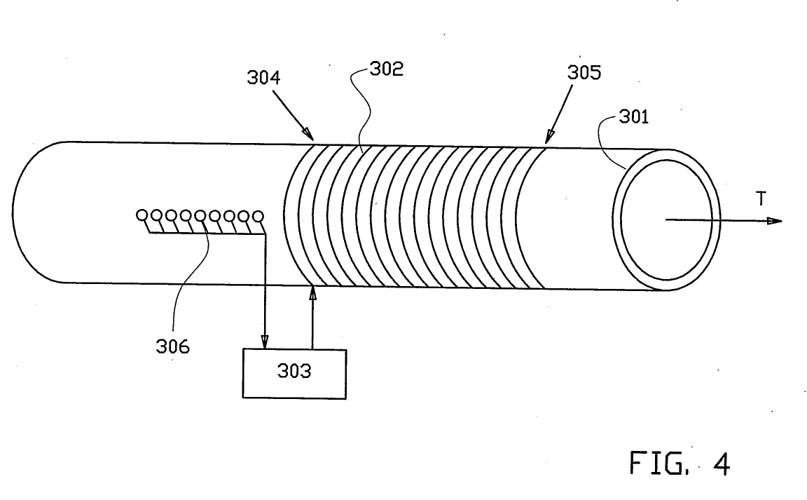

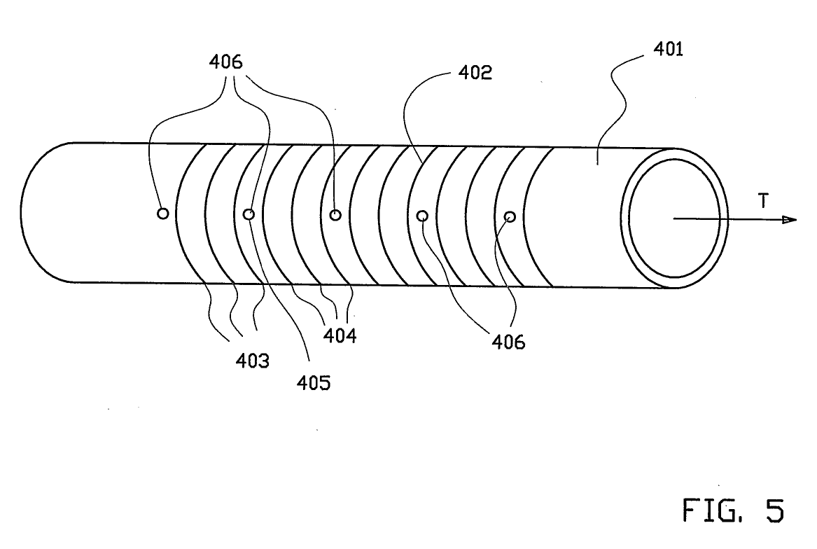

FIGS. 4 and 5 show schematic views of further exemplary embodiments of a magnetic drive mechanism;

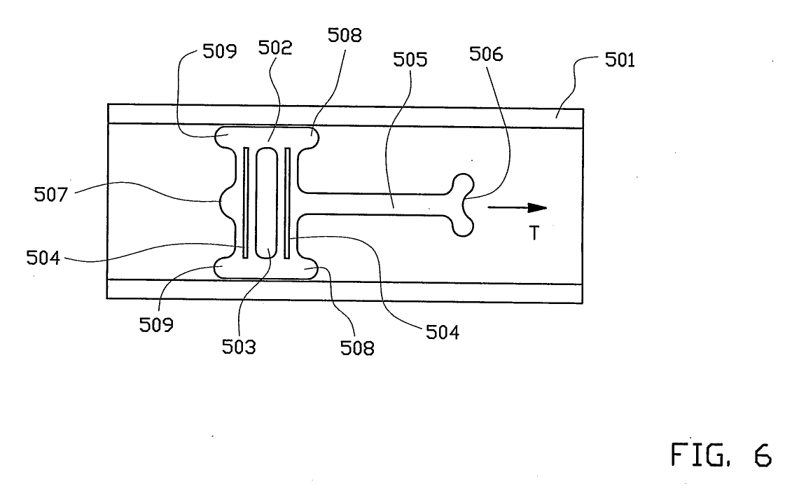

FIG. 6 shows a schematic view in cross-section of an exemplary embodiment of a conveyor flight according to the invention;

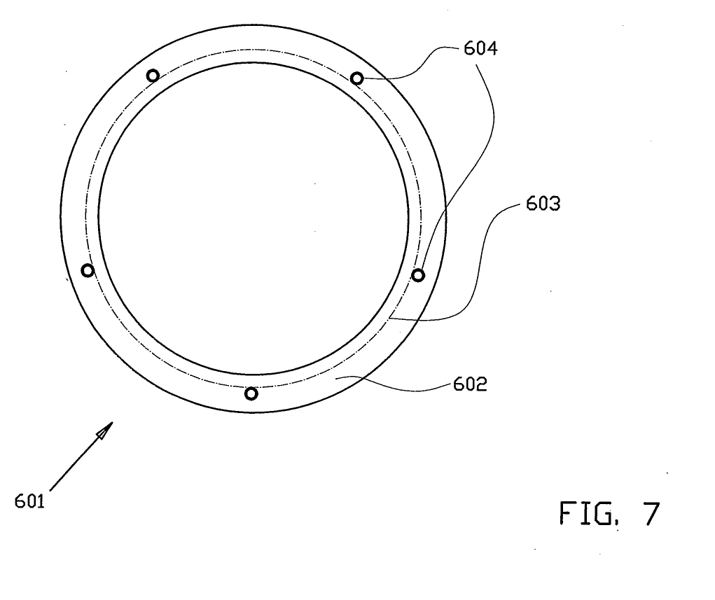

FIG. 7 shows a schematic view in cross-section of an exemplary embodiment of a conveyance tube for a conveyor according to the invention; and

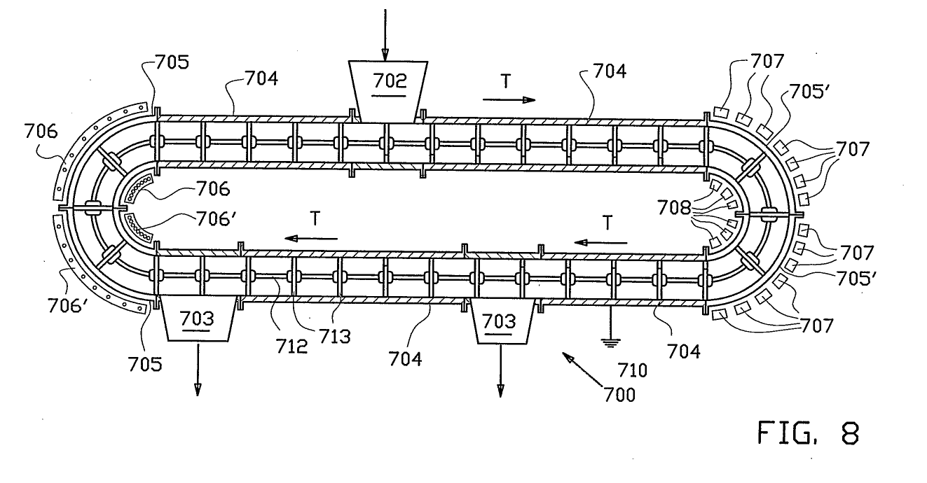

FIG. 8 shows a schematic view of a further exemplary embodiment of a conveyor according to the invention.

FIG. 1 shows an exemplary embodiment of the conveyor according to the invention. The tube circuit 100 comprises an inlet 102 and one or more outlets 103 (two outlets are shown in FIG. 1) which are connected to each other by means of conveyance tubes 104. The tube circuit may fully or partially consist of flexible conveyance tubes 104. Flexible parts of the tube circuit can be attached to a basis by means of attachment means (not shown) such as for instance shown in the FIGS. 2 and 3 of Dutch patent application 1024840. Preferably however, use is made of brackets and/or saddles (not shown) wherein the bracket and/or saddle can be brought into an opened position for placing the conveyance tube 104 in the bracket and/or saddle, and can subsequently be brought in a closed position, wherein the bracket and/or saddle fully or partially encloses the conveyance tube 104, for connecting and/or fixing the conveyance tube 104 to the basis onto which the bracket and/or saddle has been mounted. Preferably the brackets and/or saddles are made of an electrically conductive material and by means of an earth wire (not shown) are put to earth for discharging any generated static electricity.

At the inside the circulating tube circuit 100 is provided with a series of spaced apart conveyor flights (not shown) for conveying a material from the inlet 102 to one or more outlets 103. To that end the conveyor comprises one or more drive mechanisms 105 for generating a driving force, wherein the driving force drivingly engages at least a part of the conveyor flights positioned within the drive path of the drive mechanisms 105.

In the exemplary embodiment of FIG. 1 two drive mechanisms 105 are shown of which the one is placed upstream and the other is placed downstream of the inlet 102. The one or more drive mechanisms can also be placed at other locations in the circulating tube circuit 100.

FIG. 2 shows an exemplary embodiment of a drive mechanism of a conveyor according to the invention. FIG. 2A shows a part of a tube circuit 61 through which an endless circulating cable 62 has been placed which is provided with a series of spaced apart conveyor flights 63. Instead of the circulating endless cable 62 with the conveyor flights 63 placed thereon, use can also be made here of separate conveyor flights such as for instance shown in FIG. 6.

The tube portion 64 shown is made of a synthetic material through which magnetic fields are able to penetrate to the inside of the tube portion 64. The conveyor flights 63 as shown in FIG. 2C, are formed as synthetic disks 65, which contain an annular or interrupted annular magnet 66. The synthetic disk 65 envelopes the magnet 66. Similar disks 63 are attached more or less equally spaced apart from each other on the entire cable 62.

For driving the conveyor flights 63 a number of coils 70 are placed outside of the synthetic tube 64. When connecting the coils 70 to a power source a magnetic field arises having a pattern of magnetic lines of flux 71 as shown in FIG. 2B. The strength of the magnetic field among other things depends on the applied current. The magnets 66 that have been inserted into the conveyor flights 63, now wish to follow those lines of flux of the coils 70. As a result a drive in forward direction T arises. After a conveyor flight 63 has passed a first coil 80, it is attracted by the next coil 81. The subsequent conveyor flight 63 is then simultaneously attracted by the first coil 80 again. Due to this effect a continuous drive arises which can be controlled as to strength by means of the current in the coils 70.

When use is only made of the attracting force of the coils 70, the conveyor flights 63 may also be provided with magnetic materials such as ferromagnetic cores 66. When the cores 66 of the conveyor flights 63 comprise magnets, said magnets cannot only be attracted by the magnetic field of the coils 70 but also be repulsed due to which an additional drive can be achieved.

The drive using magnetic fields as shown in FIG. 2, is capable not only of exerting a driving force in forward direction T, but also a force in radial direction with respect to the tube 64. Said radial forces can be used to urge the disk-shaped conveyor flights 63 to the centre of the tube 64. When the tube circuit 61 namely comprises a bend, the cable 62 including the conveyor flights 63 will tend to rub against the inner wall of the inside bend of the tube 64. When use is made of separate conveyor flights 502 as shown in FIG. 6, said conveyor flights 502 in a bend will tend to rub against the inner wall of the outside bend of the tube 64. By placing magnets at the inside and/or outside of the synthetic tube 64 for pushing away or attracting, respectively, the conveyor flights 63, 502, the friction between the conveyor flights 63, 502 and the inner wall of the tube 64 and the wear it causes can be strongly reduced. Such guiding devices 107, 108 are schematically shown in FIGS. 1 and 8.

As the windings of the coils 70 in FIG. 2 run around the conveyance tube 64, the conveyance tube 64 is slid through the central opening of the coils when said exemplary embodiment of the conveyor according to the invention is mounted.

An alternative exemplary embodiment of a drive mechanism for a magnetic drive of the conveyor flights, is shown in FIG. 3. In this embodiment the coils for driving the conveyor flights comprise saddle-shaped windings, 202, 203, 204, 205. In case of said saddle-shaped windings it is no longer necessary to slide the conveyance tube 64 through the coils; the saddle-shaped windings can simply be placed against the outer surface of the conveyance tube 201. An advantage of this alternative embodiment is that mounting or exchanging a drive mechanism can be carried out more quickly and easily.

The coils 202, 203, 204, 205 are successively controlled so that a magnetic field travelling in the conveyance direction is generated taking along the conveyor flights. In operation the position of the travelling magnetic field has to be adjusted to the one or more conveyor flights that are positioned within the drive mechanism. In order to determine the position of the conveyor flights within the drive mechanism, this drive mechanism comprises a series of sensors 206.

As shown in FIG. 4 said series of sensors 306 can be placed upstream of the coils 302. In FIG. 4 a large number of sensors, for instance twenty-four, are placed closely next to each other so that the position of a passing conveyor flight can be accurately determined. A controlling device 303 transmits the current through the coils 302 so that a magnetic field that travels downstream T is generated. The speed of said travelling magnetic field determines the speed of the conveyor flights through the tube circuit. The travelling magnetic field starts at an upstream end 304 of the coils 302 depending on the position of a conveyor flight as determined by the sensor 306. Subsequently the controlling device sequentially transfers the excitation of the coils 202, 204 (see FIG. 3) to downstream positioned coils 203, 205 (see FIG. 3), as a result of which the travelling magnetic field moves in downstream direction T and takes along the conveyor flight. The travelling magnetic field ends at a downstream end 305 of the coils 302.

As shown in FIG. 5 said series of sensors 406 can also be placed between the coils 402. The excitation of the coils 403 can in this case be sequentially transferred to downstream positioned coils 404 when an adjacent sensor 407 detects the presence of a conveyor flight.

FIG. 6 shows an exemplary embodiment of a conveyor flight 502 according to the invention. Said conveyor flight 502 has a disk-shaped body having two end surfaces, of which a first end surface is provided with a spacer 505. The outer circumference of the disk-shaped body is at least almost equal to the inner circumference of the tube circuit 501. The disk-shaped body is provided with circumferential edges 508, 509, which circumferential edges on both sides of the disk-shaped body project substantially perpendicular out of the end surfaces of the disk-shaped body.

The spacer 505 extends along an axis through the centre of the disk-shaped body and at one of the disk-shaped body is provided with an abutment surface 506 capable of cooperating with an abutment surface 507 of an adjacently placed identical spacer.

For a magnetic drive the conveyor flight 502 is provided with a magnet 503, preferably an Nd-magnet, which preferably is placed in the disk-shaped body. Metal plates 504 are placed on both sides of the magnet 503.

FIG. 7 shows a view in cross-section of an exemplary embodiment of a conveyance tube 601 according to the invention. Said conveyance tube 601 comprises an inner wall 603 made of polyurethane (PU) and an outer wall 602 made of a carbon-filled regenerate for discharging static electricity.

In the wall of said conveyance tube 601 a number of guides 604 (in this case five) have been placed. When said conveyance tube is placed in a conveyor as for instance shown in FIG. 1, the guides are connected to one or more detection devices 106 which couple in light, electricity or a pressurised fluid in the guides, and detect variations in the light intensity, electric voltage or gas pressure.

Finally FIG. 8 shows a further exemplary embodiment of the conveyor according to the invention. The tube circuit 700 comprises an inlet 702 and one or more outlets 703 (in FIG. 8 two outlets are shown) which are connected to each other by means of conveyance tubes 704, 705. The tube circuit 700 according to this exemplary embodiment comprises straight tubes 704 and bends 705, 705′, which are connected by means of flanges. The straight tubes 704 are made of metal, preferably stainless steel, whereas the bends 705 are made of a non-magnetic material, preferably synthetic material.

In the tube circuit 700 an endless circulating cable 712 is placed which is provided with a series of spaced apart conveyor flights 713. Instead of the circulating endless cable 712 with the conveyor flights 713 placed thereon, use can also be made here of separate conveyor flights 502 such as for instance shown in FIG. 6. The conveyor flights 713 are formed like synthetic disks in which a component (not shown) made of an electrically conductive and/or magnetic material is placed in a similar way as in the embodiment of FIGS. 2 and 6.

The two bends 705 in this embodiment are both provided with a drive mechanism 706, 706′ in the form of a linear induction motor which drivingly engages onto the conveyor flights 713 that are positioned in or near the respective bends. Apart from the drive in drive direction T, said induction motors 706, 706′ also ensure the guidance of the conveyor flights 713 through the respective bends 705.

The bends 705′ without drive mechanism, are provided with guiding devices 707, 708 for guiding the conveyor flights 713 through the respective bends 705′ as schematically shown in FIG. 8.

The bends 705, 705′ are made of electrically conductive synthetic material or are at least provided with an electrically conductive layer at the outside. Due to the flange connection the bends 705, 705′ are electrically connected to the metal tubes 704, which via an earth wire 710 are put to earth for discharging static electricity.

It is observed here that the embodiments of the invention described above are meant to be an illustration of the invention and not a limitation of the invention. Whereas the invention is shown and described referring to certain preferred embodiments thereof, it will be clear to the expert that several adjustments in shape and details can be made without deviating from the spirit and scope of protection of the invention as defined by the attached claims.

1-46. (canceled)

47. Conveyor for material, comprising
a circulating tube circuit,
a series of conveyor flights placed so as to be movable in the circulating tube circuit, comprising one or more first conveyor flights comprising a component made of an electrically conductive and/or magnetic material,
one or more spacers for spacing apart the conveyor flights in the circulating tube circuit, and
a drive mechanism comprising
a number of coils placed fixedly and consecutively along a drive member of the circulating tube circuit, for generating a varying magnetic field within a drive path for driving the first conveyor flights situated within the drive path in a drive direction, wherein the drive member is placed in a bend in the tube circuit, and
a controlling device for controlling the coils for generating a magnetic field that travels along the drive path.

48. Conveyor according to claim 47, wherein the coils comprise loop-shaped or saddle-shaped windings that at least partially enclose the drive member of the tube circuit, and wherein the loop-shaped or saddle-shaped windings can be folded open for placing said windings around the drive member of the tube circuit.

49. Conveyor according to claim 47, wherein the drive mechanism comprises sensors for detecting a position and/or the speed of the at least one first conveyor flights with respect to the coils, and wherein the sensors are connected to the controlling device for transmitting data regarding the position and/or the speed to the controlling device, wherein the controlling device is adapted for excitation of the coils in dependency on the position and/or the speed of the at least one first conveyor flights.

50. Conveyor according to claim 49, wherein the sensors are placed upstream of the coils and/or between the windings of the coils.

51. Conveyor according to claim 47, wherein a conveyance tube of at least a part of the tube circuit at least near a drive member of the circulating tube circuit, is substantially made of a synthetic material.

52. Conveyor according to claim 47, wherein each of the conveyor flights comprises at least one disk-shaped body having an outer circumference that is at least almost equal to the inner circumference of the tube, wherein the one or more spacers comprise a circulating endless conveyance means, wherein the conveyor flights are coupled to the conveyance means at least a regular distance from each other.

53. Conveyor according to claim 47, wherein each of the conveyor flights comprises at least one disk-shaped body having an outer circumference that is at least almost equal to the inner circumference of the tube, wherein the conveyor flights each comprise a spacer, wherein the spacer projects from the conveyor flights in the direction of a next adjacent conveyor flight in the tube circuit.

54. Conveyor according to claim 53, wherein the disk-shaped body comprises a circumferential edge which circumferential edge projects out of the plane of the disk-shaped body, wherein the circumferential edge projects substantially perpendicular out of the plane of the disk-shaped body.

55. Conveyor according to claim 54, wherein the circumferential edge on both sides of the disk-shaped body projects out of the plane of the disk-shaped body.

56. Conveyor according to claim 53, wherein the spacer of a conveyor flight can be coupled to a next adjacent conveyor flight, wherein the one or more spacers substantially connect to the centre of the disk-shaped body.

57. Conveyor according to claim 47, wherein the conveyor comprises one or more magnet means placed along the tube circuit for generating a magnetic field for urging at least the first conveyor flights to the centre of a tube of the tube circuit, wherein a conveyance tube of at least a part of the tube circuit at least near the magnet means, is substantially made of a non-magnetic material, preferably of synthetic material.

58. Conveyor according to claim 57, wherein the one or more magnet means are placed in a bend in the tube circuit where no drive member has been placed.

59. Conveyor according to claim 57, wherein the one or more magnet means comprises electromagnets.

60. Conveyor according to claim 47, wherein a wall of the conveyance tube of at least a part of the tube circuit is provided with one or more guides placed in the tube circuit and extending along the drive direction, which guides guide a medium, such as for instance light, electricity, a fluid or a fluid pressure, wherein the conveyor comprises a wear sensor which is connected to the one or more guides for detecting deviations in the medium, such as for instance a variation in the light intensity, electric voltage or fluid pressure.

61. Conveyor according to claim 47, wherein the conveyance tube is at least partially made of metal or an electrically conductive synthetic material.

62. Conveyor according to claim 47, wherein the conveyance tube is provided with an electrically conductive layer for discharging static electricity, wherein the electrically conductive layer preferably is disposed at the outer side of the conveyance tube, wherein the electrically conductive layer preferably comprises a carbon-filled synthetic material, preferably a carbon-filled recycled synthetic material.

63. Drive mechanism for a conveyor for material comprising conveyor for material, comprising a circulating tube circuit, a series of conveyor flights placed so as to be movable in the circulating tube circuit, comprising one or more first conveyor flights comprising a component made of an electrically conductive and/or magnetic material, one or more spacers for spacing apart the conveyor flights in the circulating tube circuit, wherein the drive mechanism comprising
a number of coils placed fixedly and consecutively along a drive member of the circulating tube circuit, for generating a varying magnetic field within a drive path for driving the first conveyor flights situated within the drive path in a drive direction, wherein the drive member is placed in a bend in the tube circuit, and
a controlling device for controlling the coils for generating a magnetic field that travels along the drive path.

64. Guiding device for a conveyor for material comprising a circulating tube circuit, a series of conveyor flights placed so as to be movable in the circulating tube circuit, comprising one or more first conveyor flights comprising a component made of an electrically conductive and/or magnetic material, one or more spacers for spacing apart the conveyor flights in the circulating tube circuit, wherein the guiding device comprises one or more magnet means placed along the tube circuit for generating a magnetic field for urging at least the first conveyor flights to the centre of a tube of the tube circuit.

65. Guiding device according to claim 64, wherein the one or more magnet means are placed in a bend in the tube circuit where no drive member has been placed, wherein the one or more magnet means comprises electromagnets.

66. Use of a conveyor for conveying material, comprising a circulating tube circuit, a series of conveyor flights placed so as to be movable in the circulating tube circuit, comprising one or more first conveyor flights comprising a component made of an electrically conductive and/or magnetic material, one or more spacers for spacing apart the conveyor flights in the circulating tube circuit, and a drive mechanism comprising a number of coils placed fixedly and consecutively along a drive member of the circulating tube circuit, wherein the drive member is placed in a bend in the tube circuit, and a controlling device for controlling the coils,
by generating a varying magnetic field within a drive path that travels along the drive path for driving the first conveyor flights situated within the drive path in a drive direction, and for guiding the first conveyor flights through the bend by preventing to large extend that in the bend the conveyor flights rub against the inner wall of the tube circuit.
